(19) United States
(12) Patent Application Publication
(10) Pub. No.: US 2001/0029675 A1
(43) Pub. Date: Oct. 18, 2001

(54) Laser beam alignment device

(76) Inventor: James Webb, Torrance, CA (US)

Correspondence Address: Roger A. Marrs, Suite 1120, 15233 Ventura Blvd., Sherman Oaks,, CA, 91403, US

(21) Appl. No.: 09/740,523

(22) Filed: Dec. 19, 2000

Related U.S. Application Data
(60) Provisional application No. 60/172,800, filed on Dec. 21, 1999.

(51) Int. Cl. G01C 15/00

(52) U.S. Cl. 33/286

(57) ABSTRACT

An alignment system for directing the generated output of a sound, light source, or visual device from a loud speaker, light generator or camera to a specifically selected target area wherein the system includes a precision laser generator carried on a selected end of a body for generating a linear laser beam. An adjustable lined generator device is carried between the body and a mounting means for the body allowing quick referencing of any dispersion angles. By employing the variable adjustment beams, the interaction between the generated beam and sound waves and an existing room geometry can be visually observed. The adjustable means produces a laser line at variable fan angles to match reference beam or wave dispersion angles.

Priority claimed on Ser. No. 60/172,800 filed Dec. 21, 1999

### BACKGROUND OF THE INVENTION

1. Field of the Invention

The present invention relates to the field of alignment systems, and more particularly to a novel adjustable line generator system for aligning and/or directing the audio or visual output from a sound, lighting or camera system to a remote position or target with laser accuracy.

2. Brief Description of the Prior Art

In the past, conventional systems such as sound, lighting or camera have employed loud speakers, lights or camera for generating and distributing sound and light wave energy into a room or directed towards a target for audience listening or viewing purposes. In the instance of sound systems, loud speakers are employed which use speaker cones to vibrate in order to generate sound waves and the sound waves emanate from the center of the speaker cone in a specific direction. In the instance of lighting systems, a light source generates a beam which is directed in a given direction to a given target which is remote from the light source. When cameras are used, the optical axis of the camera is pointed or directed towards a remote target. In all such systems, alignment of the axis of the generating device to the target is important and the exact angles that the generated beam projects from the speaker, light source, or the pointing of the camera is important. Therefore, it is important to note the exact angles which are projected from a particular source so as to qualify any specific treatment or alignments by noting the disbursement or distribution angle or surface area affected or the consequence of a revealed path. Such notation or determination should be done with accuracy, economically and without labor intensive equipment or procedures.

Problems and difficulties have been encountered when employing conventional alignment systems in connection with sound, lighting or camera systems in that the generated waves, beams or pointing procedures are non-directional and indiscriminate output from such systems has a tendency to radiate throughout a room or is not sufficiently accurate to gain maximum alignment. Alignment is generally done employing a personal judgement factor by the person doing the aligning and in some instance, separate equipment such as meters or the like, are employed. No directional or alignment practices are followed other than broadly pointing the beam source or a camera in the direction of the audience or other target area. Thus, the distribution of sound waves, light beams or visual alignment can be considered non-directional and no attempt has been made to align the output of such sources with a specific target.

Therefore, a long standing need has existed to provide an alignment system which provides an innovative approach to optimizing the efficiency and quality potential of home or professional lighting, sound, or camera systems. Such a system must be able to “certifiably” direct and align any audio, visual or lighting system output for maximum performance and quality. Such a system must allow the user, for example, to determine exact angles of sound or beam projection from a speaker or light source, thereby qualifying any specific acoustical, lighting, or visual treatment of alignments necessary to establish disbursement angle or surface area.

### SUMMARY OF THE INVENTION

Accordingly, the above problems and difficulties are avoided by the present invention which provides a novel alignment system for directing the generated output of a sound, light source or visual device from a loud speaker, light generator or camera to a specifically selected target area wherein the system includes an elongated alignment device having a cylindrical body with opposite ends for mounting a visual alignment means such as a precision laser generator. The generator is carried on a selected end of the body for generating a linear laser beam and adjustable lined generator means are carried between the body and a mounting means for the body for allowing quick referencing of any dispersion angles. By employing the variable adjustment beams, the interaction between the generated beam or sound waves and an existing room geometry can be visually observed. The adjustable means produces a laser line at variable fan angles to match reference beam or wave dispersion angles.

The laser generator in the body lies on a central longitudinal axis thereof. The end of the body opposite from its end carrying the laser generator employs a detachable mounting means which in one form includes magnetic means for releasably connecting with a magnetic component carried on the face of a case or a cabinet for a beam or wave generating source. The case or cabinet includes a front panel having a surface which is flat and flush with the cone speakers, light source or camera lens. The mounting means such as a magnetic device is used to detachably connect the end of the body with a front face of a case or cabinet so that the body is outwardly projecting from the panel face in a canter levered fashion.

In this manner, the output beam or waves or visual indication from the generating source is directed in the direction of the laser beam outputting from the laser generator carried by the body. The laser beam is visually observable so that the face of the cabinet can be moved to a position where the laser beam and fan angles thereof points to a target area and the red dot of the laser beam is of observed at the precise location desired by the user. The axis of the laser beam and the axis of the output wave or beam generator are parallel.

Therefore, it is among the primary objects of the present invention to provide an alignment system which allows an exact laser directional alignment with the placement of a sound, lighting or camera system so that generated beams, waves or visual alignments are directed to a target area or station position.

Another object of the present invention is to provide a novel wave or beam alignment system which permits a speaker or light source housing to be precisely placed so that the outputting audio or visual waves are precisely directed to a specific location.

Yet another object of the present invention is to provide an alignment means for “certifyingly” directing and aligning beams and waves from a generating system to a precise location for optimum performance and quality.

Another object resides in providing a variable line generator for producing a super bright laser line with a fan angle that is adjustable from 15 degrees to 120 degrees so as to allow for quick referencing of any beam or wave generating disbursement angles.

Another object resides in the provision of a sound or lighting system which allows the first ever visualization of speaker or light source housing and mounting ability by generating a laser dot modulation on a target location with the audio or lighting system in operation at varying power levels.

Still another object resides in providing an alignment system and direction system for sound generators, lighting source generation or camera which enhances and optimizes quality and performance efficiency by professional and home installed systems.

### BRIEF DESCRIPTION OF THE DRAWINGS

The features of the present invention which are believed to be novel are set forth with particularity in the appended claims. The present invention, both as to its organization and manner of operation, together with further objects and advantages thereof, may best be understood with reference to the following description, taken in connection with the accompanying drawings in which:

FIG. 1 is a front, perspective view showing the novel, variable line generator system of the present invention;

FIG. 2 is an enlarged side elevational view, partly in section, illustrating the variable line generator system incorporating components which are used in creating a fan angle line;

FIG. 3 is an exploded view of the novel variable line generator system illustrating the components employed in the system as shown in FIGS. 1 and 2; and

FIG. 4 is a top plan view showing a pair of beam or wave generators incorporating the variable line generator and alignment system of the present invention and illustrating the generation of laser beams to a specific target.

### DESCRIPTION OF PREFERRED EMBODIMENT

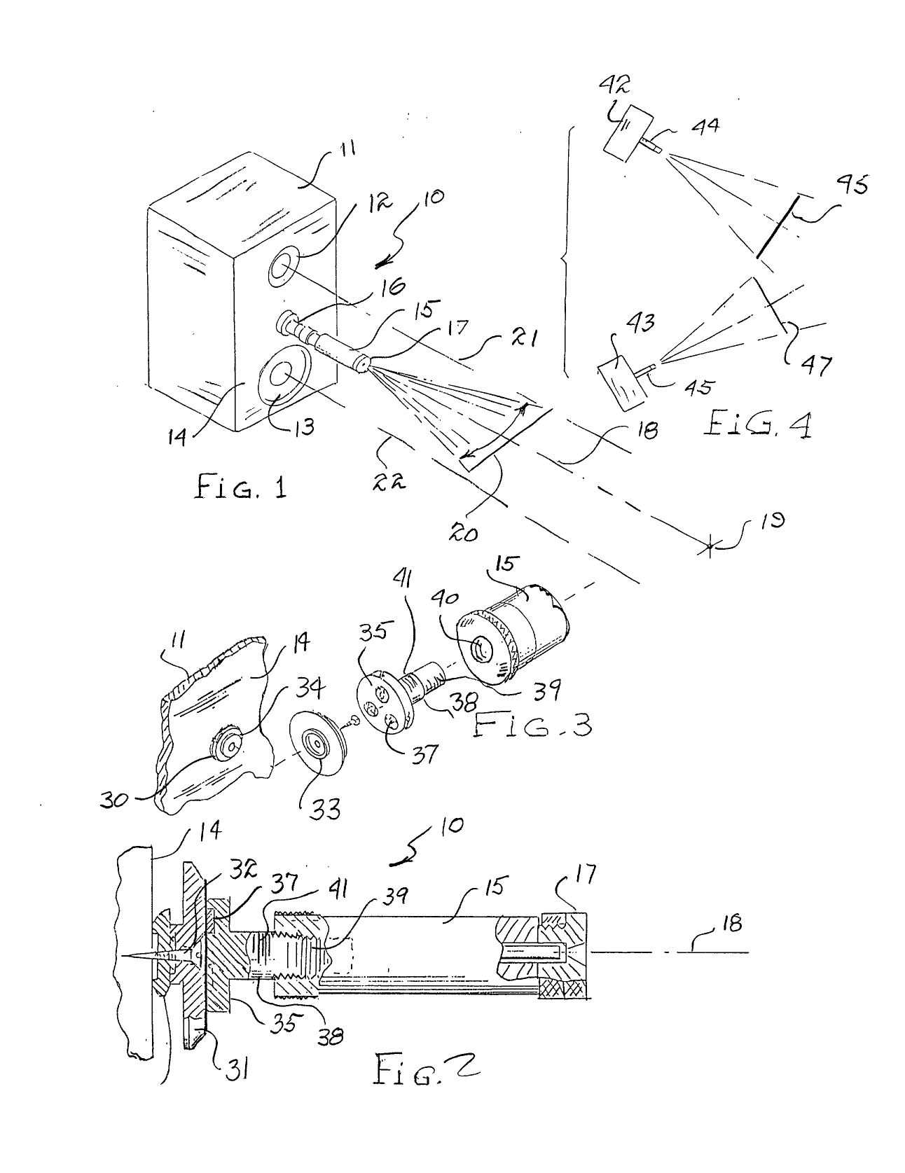

Referring to FIG. 1, the novel alignment system of the present invention is illustrated in the general direction of arrow 10 and includes a cabinet 11 mounting at least one or, as illustrated, sound wave generators such as a pair of loud speakers 12 and 13 that project through or from a front panel 14. The showing of a loudspeaker cabinet is by way of example since light sources and camera cases may also use the invention. Mounted on the flat surface of the front panel is a variable line generator device for alignment purposes and includes an elongated body 15 having a laser generator 17 mounted on one end. The body includes a mounting fixture 16 at the other end for mounting the body so that it is cantilevered outwardly from the front face of the panel 14. The opposite end of the body 15 includes the laser beam generator 17, capable of generating a laser beam 18 that terminates in a red dot or spot 19 when it strikes a target.

It is of importance to note that the beam 18 may terminate in an elongated linear line 20 which is produced by horizontally angling the projection of the beam 18 from the generator 17 between a fan angle from 15 degrees to 120 degrees. The laser line is visible and is a super bright intensity allowing for quick referencing of any speakers dispersion angle. The speakers 12 and 13 have a longitudinal dispersion axis 21 and 22 respectively and these axis are parallel to the central emission axis of the beam 18. Utilizing the variable aperture feature of the generator 17, the dispersion pattern of any tweeter or woofer loudspeaker can instantly be “seen” as it emanates from the speakers. The inner action between the generated sound waves and existing room geometry can be visually observed in any room or hall.

The variable line generator 15 employing the laser beam generator 17 can be used on any speaker system, light generating system or camera system by either holding the generator 15 flat against the face of the speaker cabinet, camera case or light source housing or by using a mounting means 16 which would then allow a “hands-free” attachment. In such a latter instance, a rare earth neodymium magnetic device may be employed.

Referring now in detail to FIG. 2 and 3, it can be seen that the body 15 of the device is elongated having opposite ends in which the laser beam generator 17 is incorporated. The generator may be attached to the front end of the body 15 by a threaded connection therewith. FIG. 3 further illustrates a mounting means for releasably connecting the body 15 to the front panel 14 of cabinet 11. Such a mounting includes a fixture 30 which is fixly secured to the flat surface of panel 14 with a spacer element 31 attached thereto by means of a screw 32. The spacer element 31 includes an alignment means 33 that is aligned with and coupled with a raised portion 34 of the mount 30. Preferably, the mounting element 31 is composed of a magnetic material and forms a component of a magnetic fastener which attracts and releasably retains a second component of a magnetic fastener which is a disk 35. The disk 35 includes a plurality of magnetic elements, such as element 37, which attracts with the magnetic component in the mounting element 31 to provide retention. The disk 35 includes an outwardly projecting shaft 38 which terminates in threads 39 intended to be threadably engaged with the internal threads in a bore 40 provided in the end of the body 15 opposite from its end carrying the laser generator 17.

It is to be particularly noted that the shaft 38 further includes indicator lines associated with indicia for visually indicating angles for establishing the linear line 20 of the laser beam. By rotating the body with respect to the disk 35, the end of the body can register with the indicia for a selected angular position. The indicia is indicate along with reference lines by numeral 41.

FIG. 2 illustrates a completely assembled variable alignment generating system wherein the body 15 is cantilevered outwardly from the flat surface of panel 15. The magnetic connection means having the components 31 and 37 connected together support the generating device on the cabinet.

As shown in FIG. 4, a pair of cabinets 42 and 43 are illustrated which have laser generators incorporated into the devices 44 and 45 respectively. Each of the devices are identical to one another but are offset in alignment so that they are both aimed at a given target such as on a wall or the like. Thus, separate laser beam lines as indicated by numerals 46 and 47 are created. In this fashion, more accurate and efficient placement of the cabinets is gained.

In view of the foregoing, it can be seen that the laser beam generators 17 may be used to create a variable line for beam and wave alignment purposes. A super bright laser line with a fan angle that is adjustable from 15 degrees to 120 degrees is provided allowing for quick referencing of any cabinet or case dispersion angle. The system produces a laser line at variable fan angles to match reference beam or wave dispersion angles.

While particular embodiments of the present invention have been shown and described, it will be obvious to those skilled in the art that changes and modifications may be made without departing from this invention in its broader aspects and, therefore, the aim in the appended claims is to cover all such changes and modifications as fall within the true spirit and scope of this invention.

What is claimed is:

1. A directional alignment system comprising:
a signal generator having a central longitudinal axis for producing and transmitting a directional beam;
a structural surface remotely spaced apart from said signal generator for receiving said directional beam;
a housing mounting said signal generator on a flat panel with said central longitudinal axis perpendicular to said flat panel; and
adjustable mounting means for detachably mounting said signal generator on said flat panel.

2. The directional alignment system defined in claim 1 including:
a beam radiating source disposed in said housing emitting a radiated beam parallel to said central longitudinal axis whereby said directional beam and said radiated beam are in fixed parallel, spaced-apart relationship with both said directional beam and said radiated beam, terminating on said structural surface.

3. The directional alignment system defined in claim 2 wherein:
said beam radiating source is selected from:
a. a light beam source;
b. a sound source;
c. an optical axis.

4. The directional alignment system defined in claim 3 wherein:
said signal generator is a laser beam generator producing an emitted laser beam in the form of a linear line on said structural surface.

5. The directional alignment system defined in claim 4 wherein:
said adjustable mounting includes a two-component magnetic coupler releasably joining said signal generator with said housing.

6. The directional alignment system defined in claim 5 wherein:
each of said two-components includes threadable fasteners fixly secured to said signal generator and to said housing respectively.

7. A directional alignment system comprising:
a housing having a front panel and enclosing a radiating beam generator emitting a radiating beam perpendicular to said front panel;
an elongated cylinder detachably mounted on said front panel and having a laser beam generator therein for emitting a laser beam in a fan-shaped array to provide a linear line;
a flat structural surface remote from said housing for visually exposing said laser beam fan-shaped array; and
said cylinder having a central longitudinal axis parallel with said radiating beam.

8. The directional alignment system defined in claim 7 including:
magnetic mounting means coupling said cylinder with said front panel.

9. The directional alignment system defined in claim 8 including:
a second housing with a second laser beam generator cooperating with said first mentioned laser beam generator to establish disbursement angle between said radiated beam and said laser beam.
